(19) United States
(12) Patent Application Publication
(10) Pub. No.: US 2025/0183626 A1
(43) Pub. Date: Jun. 5, 2025

(54) SPARK PLUG ELECTRODE COMPONENT, SPARK PLUG, AND METHOD OF MANUFACTURING SAME

(71) Applicant: FEDERAL-MOGUL IGNITION GMBH, Neuhaus-Schierschnitz (DE)

(72) Inventors: Daniel Koenig, Rodental (DE); Simon Artschwager, Lautertal (DE); Alexander Boiko, Meeder (DE)

(21) Appl. No.: 18/960,163

(22) Filed: Nov. 26, 2024

Related U.S. Application Data
(60) Provisional application No. 63/605,068, filed on Dec. 1, 2023.

(51) Int. Cl. H01T 13/39; H01T 21/02

(52) U.S. Cl. CPC H01T 13/39; H01T 21/02

(57) ABSTRACT

A spark plug electrode component and spark plug having a grain structure configured to improve erosion resistance. The spark plug electrode component in one example includes a sparking surface end plane and a sparking body comprised of a plurality of metallic grains. Each grain of the plurality of grains has a grain axis that extends through a longest extent of each grain. At the sparking surface end plane, at least 30% of the grain axes are non-orthogonally oriented with respect to the sparking surface end plane. In some examples, there are one or more layer planes at the sparking surface end plane that are offset at a non-orthogonal angle from the spark plug axis. An additive manufacturing method may be used to make the spark plug electrode component.

### FIELD

This disclosure generally relates to spark plugs and other ignition devices for internal combustion engines, and more particularly, to spark plug electrode components having a sparking surface.

### BACKGROUND

Spark plugs can be used to initiate combustion in internal combustion engines. Spark plugs typically ignite a gaseous composition, such as an air/fuel mixture, in an engine cylinder or combustion chamber by producing a spark across a spark gap defined between two or more electrodes. Ignition of the gaseous composition by the spark causes a combustion reaction in the engine cylinder that causes the power stroke of the engine. The high temperatures, high electrical voltages, rapid repetition of combustion reactions, and the presence of corrosive materials in the combustion gases can create a harsh environment in which the spark plug functions. This harsh environment can contribute to erosion and corrosion of the firing pads and electrodes, which can negatively affect the performance of the spark plug over time, potentially leading to a misfire or some other undesirable condition.

To reduce erosion of the spark plug electrodes, various types of precious metals and their alloys—such as those made from platinum and iridium—have been used. These materials, however, can be costly. Thus, spark plug manufacturers sometimes attempt to minimize the amount of precious metals used with an electrode by using such materials only at a firing tip of the electrodes where a spark jumps across a spark gap. This leads to a multi-component spark plug electrode (e.g., precious metal, structural body, core) that can withstand the high thermal loads and help optimize heat dissipation from the spark gap to the cylinder head while resisting spark erosion.

However, while the precious metal firing tips of multi-component spark plug electrodes can be used to help minimize spark erosion, they are typically manufactured in a way so as to orient the grains of the crystal structure in a longitudinal direction. An example is schematically illustrated in FIGS. 1 and 2. More particularly shown in FIG. 2, the precious metal components, which are typically manufactured from drawn wire or rolled sheet metal, results in a texturized structure in the processing direction D. Given this, there are large grains and few grain boundaries available to oppose the erosive attack. Having more grain boundaries can help act as an obstacle for erosion, since the grain boundaries cause orientation disturbances in the atomic lattice. Additionally, orienting the grain boundaries more particularly with respect to the spark gap can further help minimize erosion.

### SUMMARY

In one embodiment, there is provided a spark plug electrode component comprising a sparking surface end plane and a sparking body comprised of a plurality of metallic grains. Each grain of the plurality of grains has a grain axis that extends through a longest extent of each grain. At the sparking surface end plane, at least 30% of the grain axes are non-orthogonally oriented with respect to the sparking surface end plane.

In some embodiments, a majority of the grain axes at the sparking surface end plane are oriented at an angle at or between 5-15° with respect to the sparking surface end plane. 90% or more of the grain axes of each grain of the plurality of grains can be non-orthogonally oriented with respect to the sparking surface end plane, and an average grain diameter of the plurality of grains may be between 5-20 μm, inclusive.

In some embodiments, the sparking body comprises a plurality of layers and a spark plug axis extends orthogonally through the sparking surface end plane, wherein each layer of the plurality of layers of the sparking body has a layer plane, and one or more layer planes at the sparking surface end plane are offset at a non-orthogonal angle from the spark plug axis.

In some embodiments, the sparking body is a firing tip and the sparking surface end plane defines a sparking surface of the firing tip or defines an end surface adjacent an annular-shaped sparking surface. The firing tip can be attached to a spark plug electrode. The spark plug electrode can comprise a plurality of layers, where at least some of the layers include a sheath portion and a core portion and a material composition of the sheath portion is different from a material composition of the core portion. At least some of the layers that include the sheath portion and the core portion are oriented at a non-orthogonal angle with respect to an axis extending through a longest extent of the spark plug electrode.

In some embodiments, the sparking surface end plane is coplanar with the end surface of the firing tip. The firing tip can be attached to a ground electrode and a second firing tip can be attached to a center electrode, with the second firing tip comprising a sparking surface and a sparking body comprised of a plurality of metallic grains. A majority of the grain axes at the sparking surface of the firing tip and a majority of the grain axes at the sparking surface of the second firing tip can be symmetrical with respect to a spark gap axis. The firing tip and the second firing tip can be annular rings with a circular spark gap axis. A majority of the grain axes at the sparking surface of the firing tip and a majority of the grain axes at the sparking surface of the second firing tip can be parallelly oriented.

In accordance with another embodiment, there is provided a spark plug electrode component comprising a sparking surface having a sparking surface end plane, and a sparking body comprised of a plurality of layers. A spark plug axis extends orthogonally through the sparking surface end plane, with each layer of the plurality of layers of the sparking body having a layer plane, and one or more layer planes at the sparking surface end plane are offset at a non-orthogonal angle from the spark plug axis.

In some embodiments, the sparking body is comprised of a plurality of metallic grains, with each grain of the plurality of grains having a grain axis that extends through a longest extent of each grain. At the sparking surface end plane, at least 30% of the grain axes are non-orthogonally oriented with respect to the sparking surface end plane.

In some embodiments, the sparking body is a firing tip for a spark plug electrode and the sparking surface end plane defines a sparking surface of the firing tip or defines an end surface adjacent an annular-shaped sparking surface.

In accordance with another embodiment, there is provided an additive manufacturing process for manufacturing a spark plug electrode component. The method includes the steps of: directing a laser or a powder bed at a non-orthogonal angle with respect to each other; melting or sintering a layer of powder on the powder bed surface; creating a plurality of layers to form a sparking body. At least some layers of the plurality of layers intersect with a sparking surface end plane.

In some embodiments, the sparking body is a hollow cylinder, and the method further comprises the step of cutting the hollow cylinder into an annular-shaped firing tip. The directing step may comprise directing the powder bed at the non-orthogonal angle by tilting the powder bed with one or more support members.

Various aspects, embodiments, examples, features, and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### DRAWINGS

Preferred example embodiments will hereinafter be described in conjunction with the appended drawings, wherein like designations denote like elements, and wherein:

FIG. 1 is a cross-section view of a center electrode according to the prior art;

FIG. 2 is an enlarged view of the sparking end of the prior art center electrode depicted in FIG. 1;

FIG. 3 is a cross-sectional view of a spark plug according to one embodiment;

FIG. 4 is an enlarged schematic view of the sparking end of the spark plug of FIG. 1;

FIG. 5 is an enlarged schematic view of an alternate configuration of a sparking end for a spark plug, such as the spark plug of FIG. 3;

FIG. 6 shows an enlarged view of a sparking surface, such as the sparking surface of the spark plug firing end of FIGS. 3-5;

FIG. 7 is an enlarged view of the firing end of FIG. 5, according to one embodiment;

FIG. 8 is an enlarged view of a firing end according to another embodiment;

FIG. 9 is a partial view of an end face of the firing end of FIGS. 5 and 7;

FIG. 10 shows an example layer that may be used to manufacture a spark plug electrode component;

FIG. 11 schematically illustrates an example manufacturing method that can be used to make a spark plug electrode component;

FIG. 12 schematically illustrates another example manufacturing method that can be used to make a spark plug electrode component;

FIG. 13 schematically illustrates another example manufacturing method that can be used to make a spark plug electrode component;

FIG. 14 shows a firing tip obtained from the spark plug electrode component of FIG. 13;

FIG. 15 shows a prior art grain structure;

FIG. 16 shows a grain structure in accordance with the present embodiments;

FIG. 17 shows a prior art grain structure;

FIG. 18 shows a grain structure in accordance with the present embodiments;

FIG. 19 shows an example metallic grain;

FIG. 20 shows another example metallic grain;

FIG. 21 shows another example metallic grain; and

FIG. 22 schematically illustrates an additive manufacturing process.

### DESCRIPTION

The spark plug electrode components of the present disclosure can improve the life of the spark plug by effectively minimizing spark-induced erosion. As detailed herein, the grain structure at the sparking surface of the spark plug is particularly configured to orient grain boundaries in a preferential fashion, also while increasing the number of grain boundaries to help enhance erosion resistance. The grain boundaries can help act as an obstacle for any kind of erosion, since the grain boundaries cause orientation disturbances of the atomic lattice. Grain boundary precipitation can occur if the electrode material is subjected to dynamically changing or high thermal loads, which have a negative effect on the performance and service life of the spark plug. This grain boundary precipitation can cause cracks along the grain boundaries, which impede the flow of heat from the spark gap to the cylinder head. This can lead to overheating of the electrode (pre-ignition) or to complete failure of the spark plug. Accordingly, strategically configuring the grain structure can help improve spark plug functionality while minimizing spark-induced erosion.

The spark plug electrode components described herein can be used in spark plugs and other ignition devices including industrial plugs, aviation igniters, or any other device that is used to ignite a gaseous composition mixture in an engine. This includes spark plugs used in automotive internal combustion engines, and particularly in engines equipped to provide gasoline direct injection (GDI), engines operating under lean burning strategies, engines operating under fuel efficient strategies, engines operating under reduced emission strategies, or a combination of these. The various spark plug electrode components may provide enhanced erosion resistance, effective pad retention, and cost-effective solutions for the use of precious metal, to cite some possible improvements.

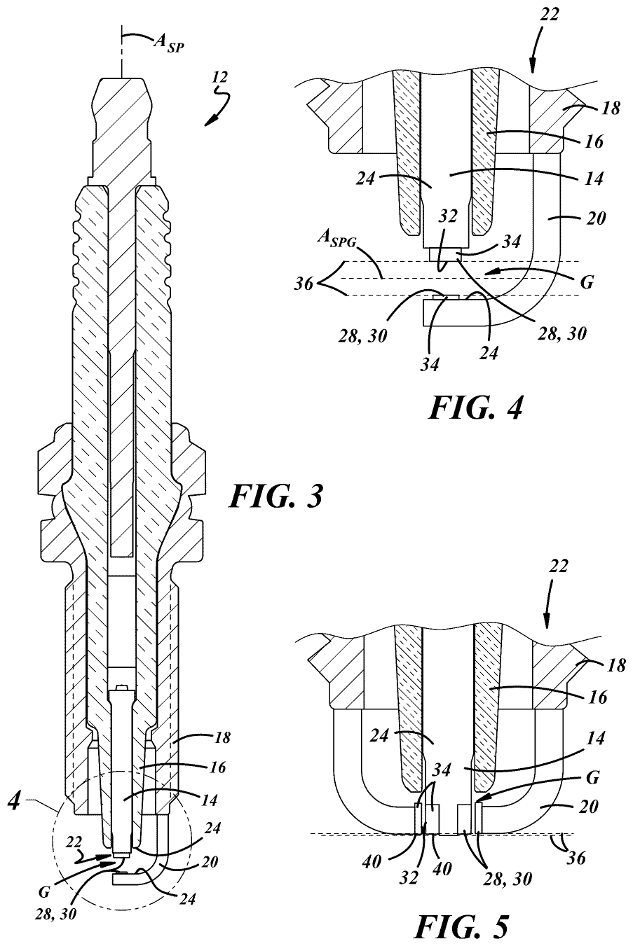

Referring to FIG. 3, a spark plug 12 includes a center electrode 14, an insulator 16, a metallic shell 18, and a ground electrode 20. Other components can include a terminal stud, an internal resistor, various gaskets, and internal seals, all of which are known to those skilled in the art. The center electrode 14 is generally disposed within an axial bore of the insulator 16 at an internal step, and may have an end portion exposed outside of the insulator at a firing end 22 of the spark plug 12. The center electrode 14 and/or the ground electrode 20 could be alternately configured than what is particularly illustrated in the figures (e.g., not a standard J-gap configuration or annular shaped firing tips on one or more of the electrodes 14, 20). The insulator 16 is generally disposed within an axial bore of the metallic shell 16, resting against an internal step of the shell bore, and has an end nose portion that may be at least partially exposed outside of the shell at the firing end of the spark plug 12. The insulator 16 is made of a material, such as a ceramic material, that electrically insulates the center electrode 14 from the metallic shell 18. The metallic shell 18 provides an outer structure of the spark plug 12, and has threads for installation in an engine.

In one example, the center electrode 14 and/or ground electrode 20 is made of a non-precious metal based material, or more particularly, a nickel (Ni) alloy material that serves as an external or sheath portion 24 of the body, and can include a copper (Cu) or Cu alloy material that serves as an internal core portion 26 of the body. As used herein, non-precious metal based refers to a material wherein 50 wt % or more is not a precious or noble metal (e.g., nickel-based). Similarly, precious metal based refers to a material wherein 50 wt % or more is a precious or noble metal (e.g., platinum-based). Some non-limiting examples of Ni alloy materials that may be used with the center electrode 14, the ground electrode 20, or both, include an alloy composed of one or more of Ni, chromium (Cr), iron (Fe), manganese (Mn), silicon (Si), or another element; and more specific examples include materials commonly known as Inconel® 600 or 601, which are types of nickel alloys.

With reference to the embodiments of the firing end 22 illustrated in FIGS. 4 and 5, each of the center electrode 14 and the ground electrode 20 include a spark plug electrode component 28, which in this embodiment, is a firing tip 30. In some embodiments, the spark plug electrode component 28 is not a separate firing tip 30 that is added (e.g., welded) to the center electrode 14 and/or the ground electrode 20, but instead, is the electrode 14, 20 itself. In yet other embodiments, the spark plug electrode component 28 is an alternately constructed firing tip (e.g., a column or rivet as opposed to an annular ring or firing pad), or an electrode 14, 20 or portion of an electrode that does not have a separate firing tip at all, to cite a few example possibilities. In this embodiment, however, the spark plug electrode components 28 are firing tips 30 that generally define a spark gap G.

Each spark plug electrode component 28 includes a sparking surface 32 adjacent the spark gap G and has a sparking body 34, which is the primary portion of the firing tip 30 and/or electrode 14, 20 that is adjacent the sparking surface 32. Each spark plug electrode component 28 also has a sparking surface end plane 36. For the configuration illustrated in FIGS. 3 and 4, the sparking surface end plane 36 is coplanar with the sparking surface 32, and generally oriented orthogonally with respect to the longitudinal axis A_{SP} of the spark plug 12. As used herein, terms such as generally, parallel, orthogonal, etc. are meant to include a +/−5° tolerance to account for manufacturing tolerances and slight deviations. For firing tips 30 and/or electrodes 14, 20 that have an annular shape 38, the sparking surface end plane 36 is coplanar with an end surface 40 of the annular sparking surface 32. Accordingly, with the FIG. 4 embodiment, the sparking surface end plane 36 defines the sparking surface 32 of the firing tip 30. With the FIG. 5 embodiment, the sparking surface end plane 36 defines the end surface 40 adjacent the annular shaped 38 sparking surface 32. Additionally, in some embodiments, there is not a separate firing tip 30 such that the sparking surface 32 and the sparking body 34 are integral portions of the electrode 14, 20. The configuration of the sparking end 22 may thus vary from what is particularly illustrated, with such variations being dimensional and/or configurational.

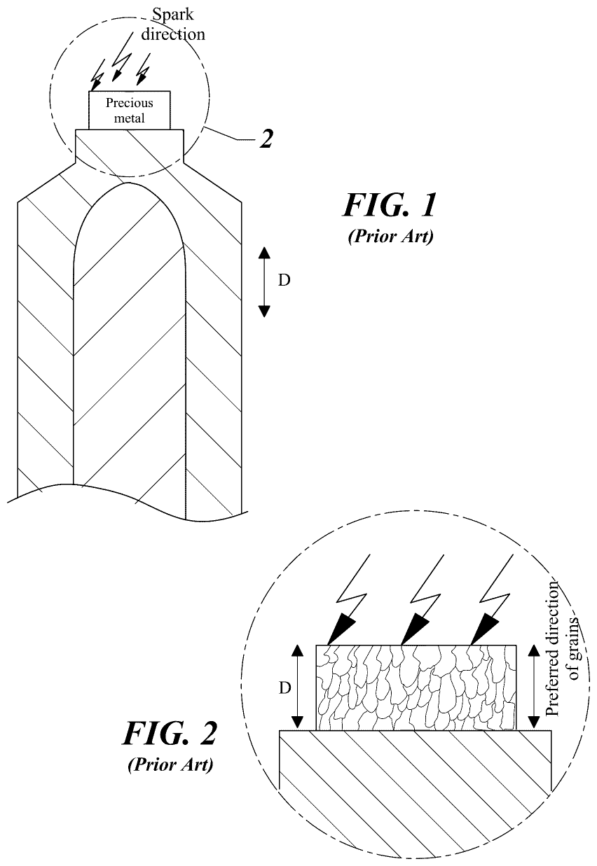

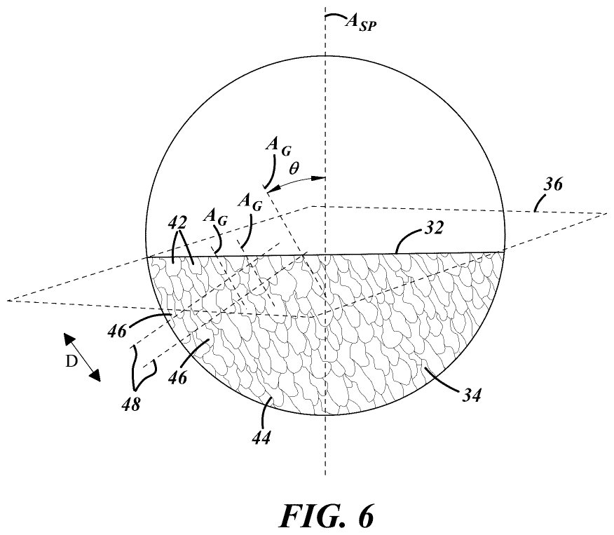

FIG. 6 is an enlarged view of the sparking body 34 at the sparking surface 32, with schematically illustrated metallic grains 42 (only a few of which are labeled for clarity purposes). Unlike the prior art grain structure illustrated in FIGS. 1 and 2, as schematically shown in FIG. 6, a majority of the grains 42 are skewed given the angled orientation of the processing direction D as it relates to the sparking surface end plane 36. Each grain 42 has a grain axis A_{G} that extends through a longest extent of each grain 42 when analyzed in cross-section. Unlike a grain structure where a large majority of the grain axes A_{G} are generally parallel to the spark plug axis A_{SP}, with the sparking body 34, more than 30%, or in some implementations, a majority of the grain axes A_{G}, or even more preferably, more than 75% or more than 90% of the grain axes A_{G} at the sparking surface 32 or end surface 40 are non-orthogonally angled with respect to the sparking surface end plane 36. This angle θ is advantageously between 2-45°, or more particularly, between and including 5-15°, with about 5-7° being easier to manufacture, as detailed further below. By having a majority of the grains 42 oriented such that the grain axis A_{G} is non-orthogonally oriented with respect to the sparking surface 32 and/or the sparking surface end plane 36, the amount of spark-induced erosion can be minimized as the orientation of the grain boundaries is less susceptible to thermal cracking. This rotation of the grain axes A_{G}, at about 5-10°, can help impart boundary strengthening, and may even make it possible so that a separate precious metal firing tip is not needed.

To achieve the grain structure 44 and the configuration of the grains 42, in one embodiment, an additive manufacturing process is used to deposit a plurality of layers 46 in the sparking body 34. Each layer 46 may thus have a corresponding layer plane 48, and by building each layer 46 at the angle θ with respect to the sparking surface end plane 36, an optimized grain structure 44 can be formed at the sparking surface 32. As schematically shown, this structure 44 can result in having a majority of the grain axes A_{G} oriented orthogonally with respect to each layer plane 48.

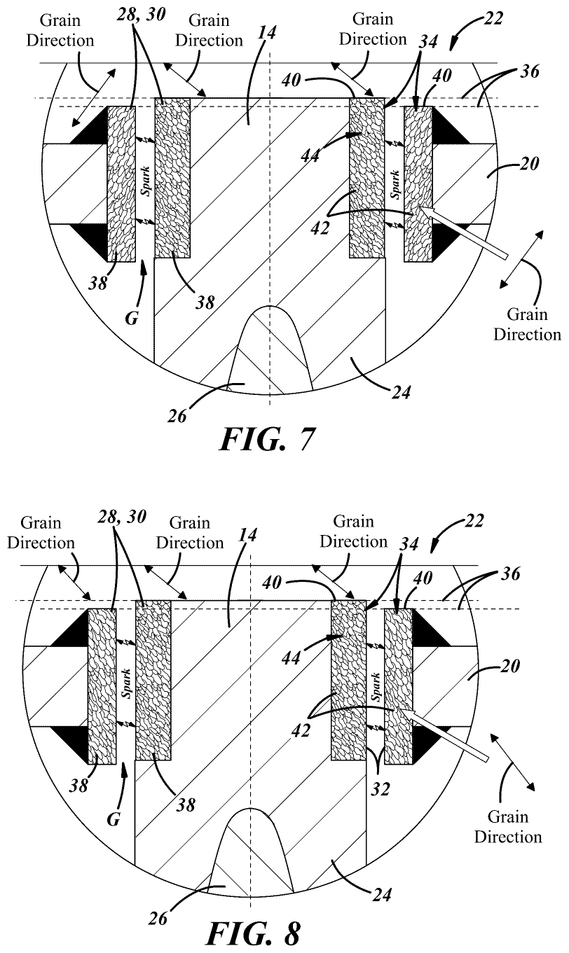

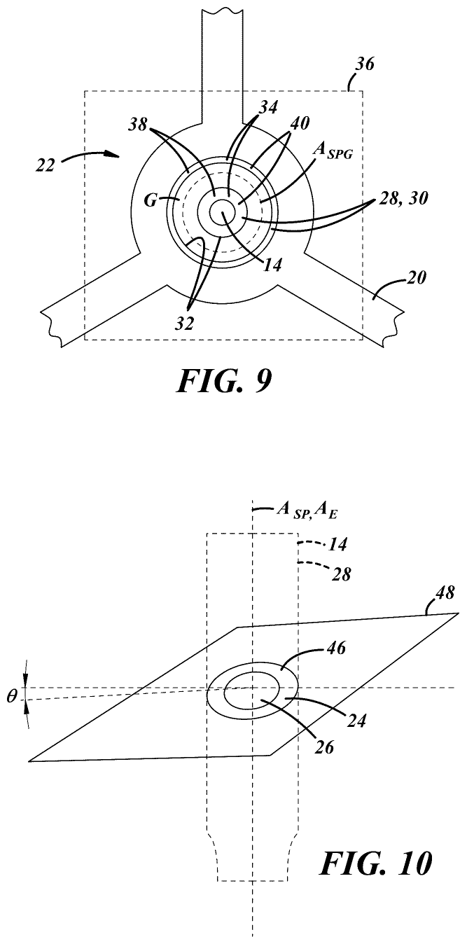

With particular reference to FIGS. 7-9, the angled orientation of the grain structure 44 can be strategically oriented to help minimize spark erosion. In each of these figures, it should be noted that the teachings regarding the grain axes A_{G} in FIG. 6 are applicable here, but the grain direction (e.g., the direction in which the majority of the grain axes A_{G} are situated) may vary depending on the desired implementation. In FIG. 7, the grain direction of the firing tip 30 on the center electrode 14 is opposite to the grain direction of the firing tip on the ground electrode 20. In the embodiment of FIG. 8, the orientation is consistent such that the grain structure 44 of the firing tip 30 on the center electrode 14 is generally parallel to the grain structure 44 of the firing tip 30 on the ground electrode 20. As shown in FIG. 9, with the annular rings 38, the spark gap axis A_{SPG} is circular, extending through the entirety of the spark gap G. With a standard J-gap, for example, the spark plug axis A_{SPG} generally bifurcates the spark gap G and is linear. The symmetrical arrangement depicted in FIG. 7 may be better at avoiding spark-induced erosion, given the oppositely skewed orientation of grains 42 on either side of the spark gap axis A_{SPG}.

In addition to the angled orientation of the grains 42 in the grain structure 44, there are other structural modifications to the grain structure that can help improve erosion resistance. In some embodiments, impurities or imperfections can help counteract crack growth and erosion. For example, impurities or imperfections may include foreign metals, foreign elements, corrosion inhibitors, an increase in the number of grain boundaries, erosion inhibitors, and disperse precipitations, to cite a few examples. In some embodiments, materials such as ceramics or tungsten could be incorporated, which are generally not soluble in the melt with the other metals that make up a majority of the composition. The addition of impurities that are not completely soluble in the alloy can be produced more easily and with higher quality (homogeneity) with powder metallurgy. In some embodiments, the grain size may be decreased to increase the number of grain boundaries at the sparking surface 32. In one example, the average grain diameter is less than 14 microns, or preferably, between 5 and 20 microns, with less than 10 microns being preferred. Additionally, an average grain area (e.g., determined by an area counting method) is less than 75 square microns, or preferably between 50 and 800 square microns, with less than 75 square microns being preferred. This fine grain structure 44, along with the skewed orientation of the grains 42, can help counteract thermal crack propagation and decrease erosion at the spark gap G. This may be partially attributable to the Hall-Petch relationship, in which yield strength may increase as grain size decreases. Simulated micrographs of the fine grain structure 44 did show a grain boundary strengthening that was achievable without mechanical deformation. These smaller grain sizes help inhibit crack growth due to frequent changes in direction, with comparatively small volume for breakage compared with larger sized grains. With larger grains, if cracking occurs along a grain boundary, the erosion rate is greater/faster since there are no obstacles to disrupt the crack growth. Thus, longer cracks can form, which can lead to loss of whole grains or more rapid loss of large volumes.

FIG. 10 shows another embodiment of a spark plug electrode component 28, which in this implementation, is a center electrode 14, although the teachings may be applicable to a ground electrode 20 implementation as well. This schematic illustration shows one layer 46 out of a plurality of layers that form the electrode 14. In an advantageous embodiment, the plurality of layers are formed via additive manufacturing in such a way that each layer 46 is angled or skewed, as described above with the firing tip 30 embodiments. The layer 46 has a sheath portion 24, preferably made of a non-precious metal based material such as Inconel® 600 or 601, which are types of nickel alloys. The sheath portion 24 generally surrounds the core portion 26, which is also preferably made of a non-precious metal based material such as copper or a copper alloy to help with heat transmission away from the spark gap G. In some embodiments, at least some layers 46 include this dual-material structure, in some embodiments, there may not be a core portion, and the layer 46 may only include a hollow sheath portion 24 or may be a solid layer without a core portion in the assembled spark plug electrode at all. A layer plane 48 is co-planar with the layer 46 to schematically illustrate its angled relationship with respect to the spark plug electrode axis A_{E}, which in this embodiment, is co-linear with the spark plug axis A_{SP}. The spark plug electrode axis A_{E} is an axis extending through a longest extent of the spark plug electrode 14, 20. Normally, the layer 46 would be deposited such that the layer plane 48 would be orthogonal with respect to the axes A_{E}, A_{SP}. However, in this embodiment, the layers 46 are skewed at the non-orthogonal angle θ, as with the previously discussed embodiments.

The spark plug electrode components 28 of the present disclosure may be used as precious-metal or non-precious metal based firing tips 30, or as the electrode 14, 20 itself. One advantage of the grain structure 44, however, is that the amount of precious metal can be reduced given the skewed structure at the sparking surface 32 to help combat spark-induced erosion. In some embodiments, due to the structural change, the use of precious metals can be completely dispensed with. In other embodiments, more cost-effective precious metal based materials can be used, such as replacing an Ir alloy with greater than 80 wt % Ir with an alloy that has closer to 50 wt % or less Ir, (e.g., substituting IrRh2.5 with IrPt50), to reduce the amount of iridium substantially and reduce the overall cost of the spark plug 12. In another embodiment, PdAu20 is used, and other materials are certainly possible.

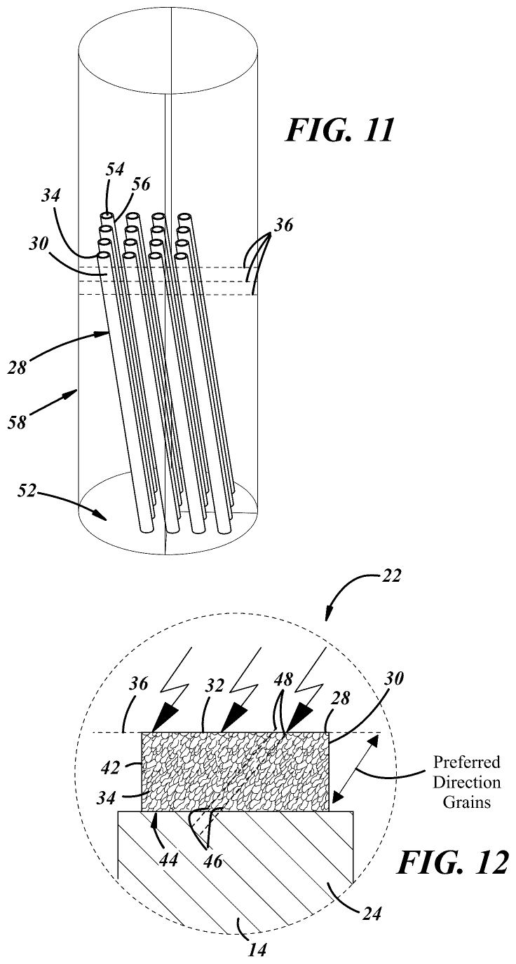

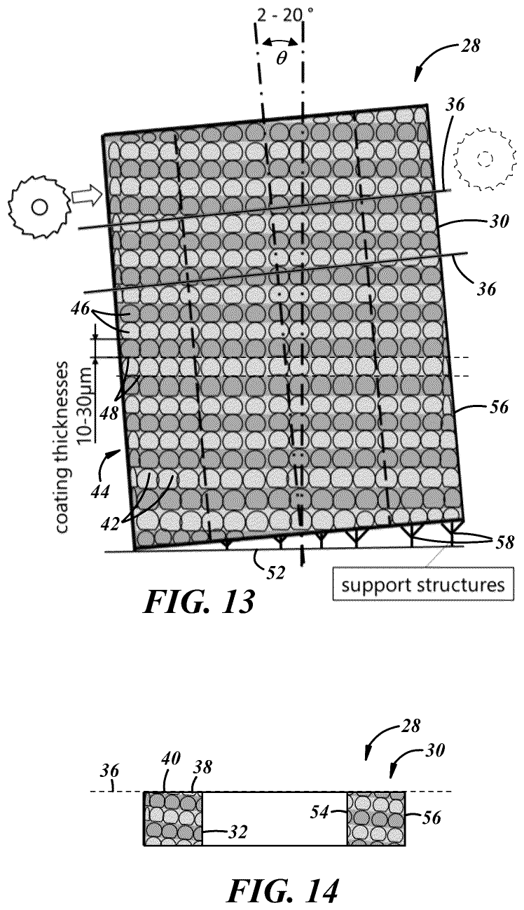

FIGS. 11-14 schematically illustrate additive manufacturing methods that may be used to manufacture the spark plug electrode components 28. In this embodiment illustrated in FIG. 11, the spark plug electrode components 28 are hollow cylindrical components or tubes that are then cut into individual firing tips 30 at the sparking surface end planes 36 (only a few of which are illustrated for clarity purposes). The spark plug electrode components 28 have canted inner and outer sidewalls 54, 56 given this manufacturing method. The spark plug electrode components 28 are manufactured at an angle θ of 7° in this embodiment, but can vary as described above with the previous embodiments (see accompanying description relating to FIGS. 13 and 14). The hollow circular cylinders 58 are then cut to length to form the annular rings 38 for firing tips 30, using a cold saw process, for example, providing the grain direction at the sparking surface end plane 36 and throughout the sparking body 34. With this arrangement, a number of the layers 46 could intersect with the sparking surface end plane given the skewed angle of each layer. FIG. 12 shows another embodiment, in which the spark plug electrode component 28 or firing tip 30 is manufactured directly on the center electrode 14. It should be noted that in this figure, only a few grains 42, layers 46, and layer planes 48 are illustrated for clarity purposes. This embodiment is better for a pad-like structure as opposed to a ring-shaped structure. In some embodiments, thermal treatment may be used before, during, or after the additive manufacturing process to help obtain the desired microstructure. Additionally, various parameters can be adjusted to influence the structure of the spark plug electrode components 28, including but not limited to, the position of the component in the powder bed, the location of optional support structures for heat dissipation during the build process, cooling rate of the built-up layer (which may by influenced by powder layer thickness, multiple exposure (grain growth) of the built-up layer or temperature of the build plate. To achieve the grain sizes described herein, the powder size and powder size distribution in the not yet melted powder may be adjusted. FIGS. 13 and 14 are schematic views of grain growth in an implementation in which the spark plug electrode component 28 is an inclined hollow cylinder 58. FIG. 13 illustrates another example manufacturing embodiment, in which the spark plug electrode component 28 is manufactured similarly to the embodiment of FIG. 11. However, in this embodiment, instead of tilting the laser, the powder bed 52 is tilted with the help of support structures 58. As shown in the cut, annular shaped firing tip 30 in FIG. 14, this manufacturing method can help impart the angled grain structure 44 at the sparking surface end plane 36. In these figures, the individual grains 42 are shown schematically as circular in shape, but it should be understood that they are likely to be more elongated/ovular in shape, and this shape/directionality may be impacted by the manufacturing process.

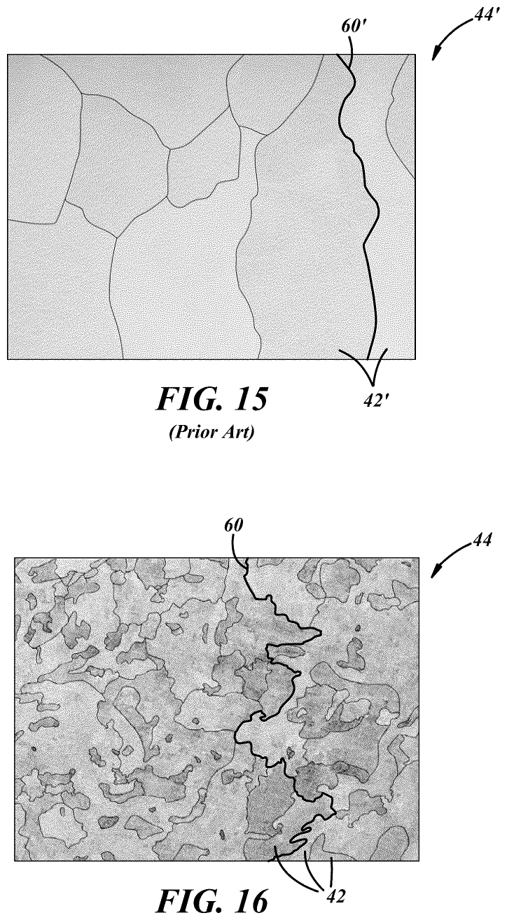

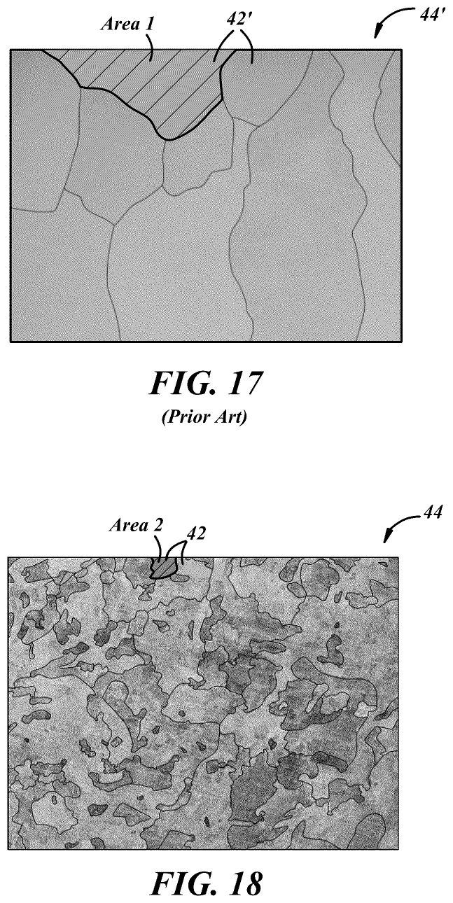

FIGS. 15-18 illustrate comparisons between prior art grain structures 44′ and grain structures 44 that can structurally be achieved using the manufacturing methods described herein. A crack 60′ along a coarse-grained boundary of the grain structures 44′ (FIG. 15) has a much shorter path than the crack 60 along a fine-grain boundary of the grain structure 44 (FIG. 16). When one or more grains 42′, 42 are torn off, this area is increased for coarse grain structures 44′ while the area is much smaller for the fine grain structure 44 when the grains 42 tear off. These comparisons in area of the grains 42′, 42 is illustrated schematically in FIGS. 17 and 18.

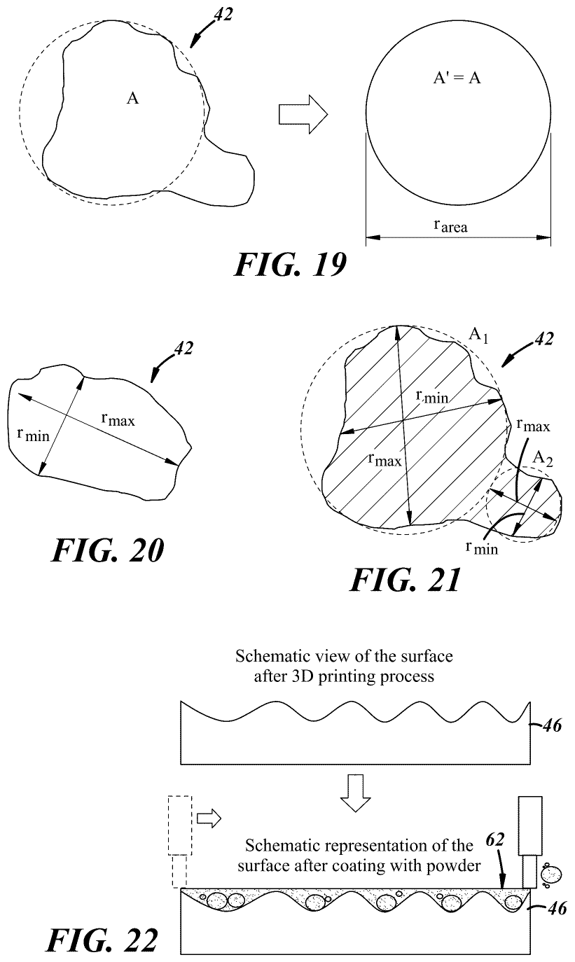

FIGS. 19-21 schematically illustrate metallic grains 42 and ways to quantify a desired geometry of the grains. The desired geometry of the grains 42 may have a compact shape. Some of this may be attributable to the process, because a change in position of the laser irradiation after each layer 46 can result in three-dimensional growth of the elongated grains 42. Accordingly, about 30% or more of the grains with an elongated shape is preferred. FIG. 19 shows an example area determination, with the radius being between about 5 and 20 microns as detailed above, and an area of less than 75 square microns being preferred. FIGS. 20 and 21 illustrate more complex shapes. In FIG. 20, the maximum radius (rₘₐₓ) is greater than the minimum radius (rₘᵢₙ) as illustrated. In this implementation, rₘₐₓ is about 1.3 to 1.5 times greater than rₘᵢₙ, with Imax being between about 5 and 20 microns, as described with respect to FIG. 19. Similar relationships between Imax and Imin are also shown in the embodiment of FIG. 21, in which two areas A1, A1 are separately determined, with again, rₘₐₓ being about 1.3 times greater than rₘᵢₙ, with rₘₐₓ being between about 5 and 20 microns.

FIG. 22 schematically illustrates the manufacture of each layer 46, showing that there is some unevenness with additive manufacturing. As addressed herein, the layer 46 thickness, laser power, and grain size of the powder 62 can have an influence on the formed grain structure 44. With the unevenness of each layer, larger particles of the powder 62 can be place on the build plate. With a flatter design, larger particles would be carried forward by the coater, and more smaller particles could be maintained within the unevenness of the last formed layer 46.

In other embodiments, additive manufacturing is not used, and another manufacturing method is used to impart the grain structure 44. For example, it is possible to reverse the change in the preferred direction of the structure by subsequent heat treatment, whether to the entire component or only at certain points (e.g., at the sparking surface 32) to selectively alter the grain structure 44 at certain places. This can be accomplished with laser or electron beam hardening, for example. However, with additive manufacturing, it is possible to incorporate imperfections such as foreign metals, grain boundaries, corrosion inhibitors, erosion inhibitors, and/or disperse precipitations. Additionally, with classic manufacturing processes, the grain geometry is physically and elementally tied to the cooling and solidification behavior. Additive manufacturing, on the other hand, allows these limits to be shifted and thus a structure to be formed which, thanks at least in part to the grain structure 44, is better able to withstand spark erosion.

It is to be understood that the foregoing is a description of one or more preferred example embodiments. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A spark plug electrode component, comprising:
a sparking surface end plane;
a sparking body comprised of a plurality of metallic grains, wherein each grain of the plurality of grains has a grain axis that extends through a longest extent of each grain, wherein at the sparking surface end plane, at least 30% of the grain axes are non-orthogonally oriented with respect to the sparking surface end plane.

2. The spark plug electrode component of claim 1, wherein a majority of the grain axes at the sparking surface end plane are oriented at an angle at or between 5-15° with respect to the sparking surface end plane.

3. The spark plug electrode component of claim 1, wherein 90% or more of the grain axes of each grain of the plurality of grains is non-orthogonally oriented with respect to the sparking surface end plane.

4. The spark plug electrode component of claim 1, wherein an average grain diameter of the plurality of grains is between 5-20 μm, inclusive.

5. The spark plug electrode component of claim 1, wherein the sparking body comprises a plurality of layers and a spark plug axis extends orthogonally through the sparking surface end plane, wherein each layer of the plurality of layers of the sparking body has a layer plane, and one or more layer planes at the sparking surface end plane are offset at a non-orthogonal angle from the spark plug axis.

6. The spark plug electrode component of claim 1, wherein the sparking body is a firing tip and the sparking surface end plane defines a sparking surface of the firing tip or defines an end surface adjacent an annular-shaped sparking surface.

7. A spark plug comprising the spark plug electrode component of claim 6, wherein the firing tip is attached to a spark plug electrode.

8. The spark plug of claim 7, wherein the spark plug electrode comprises a plurality of layers, wherein at least some of the layers include a sheath portion and a core portion, wherein a material composition of the sheath portion is different from a material composition of the core portion, wherein at least some of the layers that include the sheath portion and the core portion are oriented at a non-orthogonal angle with respect to an axis extending through a longest extent of the spark plug electrode.

9. A spark plug comprising the spark plug electrode component of claim 6, wherein the sparking surface end plane is coplanar with the end surface of the firing tip.

10. A spark plug comprising the spark plug electrode component of claim 6, wherein the firing tip is attached to a ground electrode and a second firing tip is attached to a center electrode, wherein the second firing tip comprises a sparking surface and a sparking body comprised of a plurality of metallic grains, wherein each grain of the plurality of grains has a grain axis that extends through a longest extent of each grain, wherein at the sparking surface, at least 30% of the grain axes are non-orthogonally oriented with respect to the sparking surface.

11. The spark plug of claim 10, wherein a majority of the grain axes at the sparking surface of the firing tip and a majority of the grain axes at the sparking surface of the second firing tip are symmetrical with respect to a spark gap axis.

12. The spark plug of claim 11, wherein the firing tip and the second firing tip are annular rings, and the spark gap axis is circular.

13. The spark plug of claim 10, wherein a majority of the grain axes at the sparking surface of the firing tip and a majority of the grain axes at the sparking surface of the second firing tip are parallelly oriented.

14. A spark plug electrode component, comprising:
a sparking surface having a sparking surface end plane;
a sparking body comprised of a plurality of layers; and
a spark plug axis that extends orthogonally through the sparking surface end plane, wherein each layer of the plurality of layers of the sparking body has a layer plane, and one or more layer planes at the sparking surface end plane are offset at a non-orthogonal angle from the spark plug axis.

15. The spark plug electrode component of claim 14, wherein the sparking body is comprised of a plurality of metallic grains, wherein each grain of the plurality of grains has a grain axis that extends through a longest extent of each grain, wherein at the sparking surface end plane, at least 30% of the grain axes are non-orthogonally oriented with respect to the sparking surface end plane.

16. The spark plug electrode component of claim 14, wherein the sparking body is a firing tip and the sparking surface end plane defines a sparking surface of the firing tip or defines an end surface adjacent an annular-shaped sparking surface.

17. A spark plug comprising the spark plug electrode component of claim 16, wherein the firing tip is attached to a spark plug electrode.

18. An additive manufacturing process for manufacturing a spark plug electrode component, comprising the steps of:
directing a laser or a powder bed at a non-orthogonal angle with respect to each other;
melting or sintering a layer of powder on the powder bed surface;
creating a plurality of layers to form a sparking body, wherein at least some layers of the plurality of layers intersect with a sparking surface end plane.

19. The method of claim 18, wherein the sparking body is a hollow cylinder, and further comprising the step of cutting the hollow cylinder into an annular-shaped firing tip.

20. The method of claim 18, wherein the directing step comprises directing the powder bed at the non-orthogonal angle by tilting the powder bed with one or more support members.
